(19) United States
(12) Patent Application Publication
(10) Pub. No.: US 2026/0072335 A1
(43) Pub. Date: Mar. 12, 2026

(54) PROJECTOR

(71) Applicant: SEIKO EPSON CORPORATION, Tokyo (JP)

(72) Inventors: Yusuke JONISHI, MATSUMOTO-SHI (JP); Wataru KITAHARA, SHIOJIRI-SHI (JP)

(21) Appl. No.: 19/323,047

(22) Filed: Sep. 9, 2025

(30) Foreign Application Priority Data
Sep. 11, 2024 (JP) 2024-157822

(51) Int. Cl. G03B 21/16; G03B 21/14

(52) U.S. Cl. CPC G03B 21/16; G03B 21/145

(57) ABSTRACT

A projector according to the present disclosure includes an exterior housing having an intake port through which air is taken inside, and forming an exterior, a filter attached to the intake port, an intake chamber configured to take in the air through the filter, a first fan and a second fan disposed in the intake chamber, and a partition configured to partition a first space in which the first fan is disposed and a second space in which the second fan is disposed in the intake chamber, wherein an intake capacity of the first fan is higher than an intake capacity of the second fan.

The present application is based on, and claims priority from JP Application Serial Number 2024-157822, filed September 11, 2024, the disclosure of which is hereby incorporated by reference herein in its entirety.

### BACKGROUND

### 1. Technical Field

The present disclosure relates to a projector.

### 2. Related Art

There is disclosed a projector in which optical components are cooled by outside air taken into an intake chamber provided with a plurality of intake fans from an intake port provided to an exterior housing (see, e.g., JP-A-2023-083725). In this projector, a filter that captures foreign matter such as dust contained in the outside air is disposed in the intake port.

JP-A-2023-083725 is an example of the related art.

In the projector described above, there is a problem that when clogging occurs in the intake filter when the plurality of intake fans different in output air volume from each other is disposed in one intake chamber, a backflow occurs in a fan small in output air volume to thereby make the cooling by the fan small in output air volume stop functioning, and some optical components to be cooled cannot be sufficiently cooled, which causes an operation failure.

### SUMMARY

In order to solve the problems described above, according to an aspect of the present disclosure, there is provided a projector including an exterior housing having an intake port through which air is taken inside, and forming an exterior, a filter disposed in the intake port, an intake chamber configured to take in the air through the filter, a first fan and a second fan disposed in the intake chamber, and a partition configured to partition a first space in which the first fan is disposed and a second space in which the second fan is disposed in the intake chamber, wherein an intake capacity of the first fan is higher than an intake capacity of the second fan.

### BRIEF DESCRIPTION OF THE DRAWINGS

FIG. 1 is a diagram showing a configuration of a projector according to an embodiment.

FIG. 2 is an exploded perspective view showing a configuration of an intake unit.

FIG. 3 is a plan view showing an internal configuration of the intake unit.

FIG. 4 is a diagram showing a configuration of an intake unit in a comparative example.

FIG. 5 is a diagram illustrating flow of air in the intake unit of the present embodiment.

### DESCRIPTION OF EMBODIMENTS

An embodiment of the present disclosure will hereinafter be described with reference to the drawings.

Note that in the drawings described below, elements may be illustrated at different dimensional scales in accordance with the elements in some cases in order to make the elements eye-friendly.

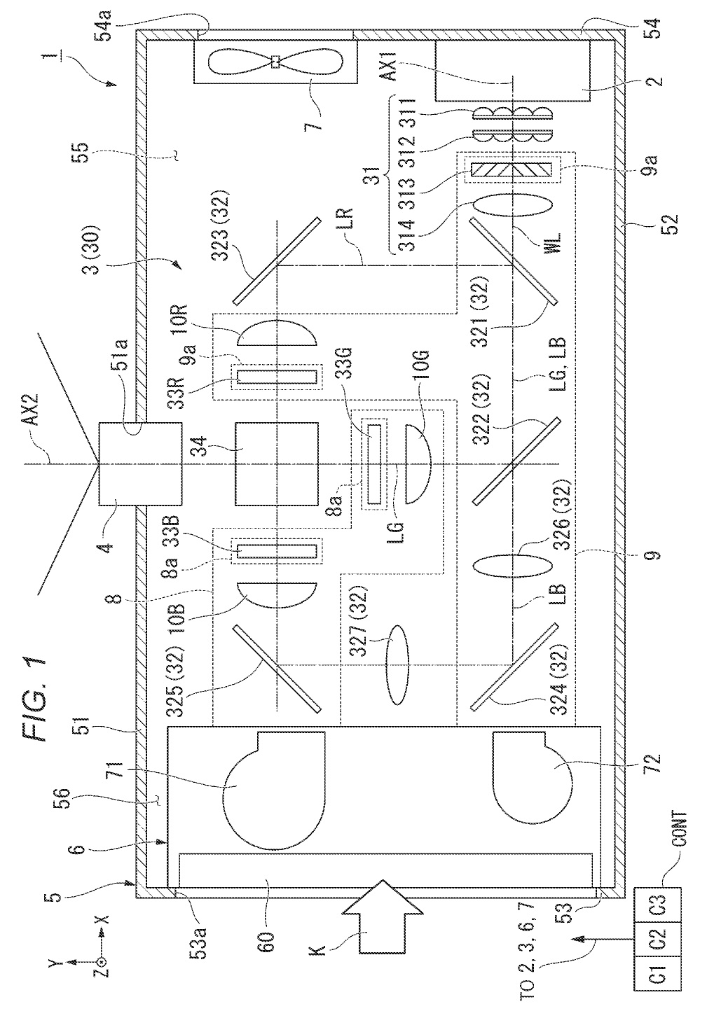

FIG. 1 shows a configuration of a projector of the present embodiment.

A projector 1 according to the present embodiment modulates illumination light emitted from the light source unit 2 to generate image light according to image information, and projects the image light thus formed on a target projection surface such as a screen in an enlarged manner. As shown in FIG. 1, the projector 1 includes a light source unit 2, an image forming unit 3, a projection optical unit 4, an exterior housing 5, an intake unit 6, an exhaust unit 7, a first duct member 8, a second duct member 9, and a control device CONT.

In the following description, an X-Y-Z orthogonal coordinate system is used as necessary.

In the drawings, the X axis is an axis along an optical axis AX1 of an illumination light WL emitted from the light source unit 2 toward the image forming unit 3. The Y axis is an axis which is orthogonal to the X axis and is parallel to a direction in which the projection optical unit 4 projects image light, that is, an optical axis AX2 of the projection optical unit 4. The Z axis is an axis orthogonal to the optical axis AX1 and the optical axis AX2.

Further, in the description of the present embodiment, a direction along the Z axis is referred to as an "up-down direction Z”, +Z is referred to as an "upper side”, -Z is referred to as a "lower side”, a direction along the X axis is referred to as a "left-right direction X”, +X is referred to as a "right side”, -X is referred to as a "left side”, a direction along the Y axis is referred to as a "front-rear direction Y”, +Y is referred to as a "front side”, and -Y is referred to as a "rear side”.

Note that the up-down direction Z, the left-right direction X, and the front-rear direction Y are merely names for describing the arrangement relationship of the components of the projector 1, but do not define the actual installation posture and direction in the projector 1.

The light source unit 2 supplies the illumination light WL as white light to an image forming section 30 of the image forming unit 3. The light source unit 2 is, for example, a halogen lamp, a mercury lamp, a light emitting diode, or a laser light source.

The image forming unit 3 includes the image forming section 30, a uniform illumination optical system 31, and a color separation light guide optical system 32. The image forming section 30 includes light modulation panels 33R, 33G, and 33B and a cross dichroic prism 34. Each of the light modulation panels 33R, 33G, and 33B modulates incident colored light in accordance with image information to form image light. Each of the light modulation panels 33R, 33G, and 33B is formed of a light-transmissive liquid crystal panel.

The cross dichroic prism 34 combines the image light emitted from the respective light modulation panels 33R, 33G, and 33B. The cross dichroic prism 34 has a substantially square planer shape obtained by bonding four rectangular prisms to each other, and dielectric multilayer films are disposed on substantially X-shaped interfaces on which the rectangular prisms are bonded to each other.

Based on such a configuration, the image forming section 30 in the present embodiment generates full-color image light by combining the image light of the respective colors.

In the present embodiment, field lenses 10R, 10G, and 10B are disposed at light incident sides of the light modulation panels 33R, 33G, and 33B, respectively.

Note that although not shown in the drawings, incident-side polarization plates are respectively disposed between the light modulation panels 33R, 33G, and 33B and the field lenses 10R, 10G, and 10B, and exit-side polarization plates are respectively disposed between the light modulation panels 33R, 33G, and 33B and the cross dichroic prism 34.

The illumination light WL emitted from the light source unit 2 enters the uniform illumination optical system 31.

The uniform illumination optical system 31 includes a first lens array 311, a second lens array 312, a polarization conversion element 313, and a superimposing lens 314.

The first lens array 311 includes a plurality of first small lenses for dividing the illumination light WL from the light source unit 2 into a plurality of partial light beams. The plurality of first small lenses are arranged in a matrix in a plane orthogonal to the optical axis AX1 of the illumination light WL.

The second lens array 312 includes a plurality of second small lenses corresponding to the plurality of first small lenses of the first lens array 311. The plurality of second small lenses are arranged in a matrix in a plane orthogonal to the optical axis AX1.

The second lens array 312 forms images of the first small lenses of the first lens array 311 in the vicinity of the image forming regions of the light modulation panels 33R, 33G, and 33B, respectively, in cooperation with the superimposing lens 314.

The polarization conversion element 313 converts light emitted from the second lens array 312 into one linearly polarized light. The polarization conversion element 313 includes, for example, a polarization separation film and a retardation plate (both not illustrated).

The superimposing lens 314 collects the partial light beams emitted from the polarization conversion element 313 to superimpose the partial light beams in the vicinity of each of the image forming areas of the light modulation panels 33R, 33G, and 33B.

The color separation light guide optical system 32 separates the illumination light WL having passed through the uniform illumination optical system 31 into red light LR, green light LG, and blue light LB and then guides the red light LR, the green light LG, and the blue light LB to the respective light modulation panels 33R, 33G, and 33B. The color separation light guide optical system 32 includes a first dichroic mirror 321, a second dichroic mirror 322, a first reflecting mirror 323, a second reflecting mirror 324, a third reflecting mirror 325, a first relay lens 326, and a second relay lens 327.

The first dichroic mirror 321 reflects the red light LR and transmits the green light LG and the blue light LB. The second dichroic mirror 322 reflects the green light LG and transmits the blue light LB out of the green light LG and the blue light LB transmitted through the first dichroic mirror 321. The first reflecting mirror 323 reflects the red light LR. The second reflecting mirror 324 and the third reflecting mirror 325 reflect the blue light LB. The first relay lens 326 is disposed between the second dichroic mirror 322 and the second reflecting mirror 324, and the second relay lens 327 is disposed between the second reflecting mirror 324 and the third reflecting mirror 325.

The projection optical unit 4 is a unit which includes a projection lens group, and on which the full-color image light combined by the cross dichroic prism 34 of the image forming section 30 is incident. Note that the projector 1 according to the present embodiment may include a lens shifting mechanism that shifts the optical axis AX2 of the projection optical unit 4.

The exterior housing 5 houses the light source unit 2, the image forming unit 3, the intake unit 6, and the exhaust unit 7 inside, and forms an exterior of the projector 1.

In the projector 1 according to the present embodiment, a heat source that generates heat during driving is housed inside the exterior housing 5. In the case of the present embodiment, examples of the heat source include the light modulation panels 33R, 33G, and 33B out of the image forming unit 3 and the polarization conversion element 313 out of the uniform illumination optical system 31.

The intake unit 6 is a unit for supplying air K taken in from the outside of the exterior housing 5 to the light modulation panels 33R, 33G, and 33B and the polarization conversion element 313 serving as the heat sources to cool the heat sources. When dust adheres to the light modulation panels 33R, 33G, and 33B and the polarization conversion element 313, which are the heat sources of the projector 1 according to the present embodiment, there is a possibility that a shadow of the dust or the like is superimposed on the image light. Therefore, the intake unit 6 of the present embodiment is assumed to include a filter 60 that captures dust contained in the air K. Note that details of a configuration of the intake unit 6 will be described later.

The first duct member 8 is a member that supplies the air K taken in by a first fan 71 of the intake unit 6 to the light modulation panels 33B, 33G as a first heat source relatively high in temperature. The first duct member 8 efficiently cools the light modulation panels 33B, 33G by blowing the air out from a blowing port 8a.

The second duct member 9 is a member that supplies the air K taken in by a second fan 72 of the intake unit 6 to the light modulation panel 33R and the polarization conversion element 313 as a second heat source lower in temperature than the first heat source. The second duct member 9 efficiently cools the light modulation panel 33R and the polarization conversion element 313 by blowing the air out from a blowing port 9a.

The control device CONT controls operations of elements of the projector 1. The control device CONT includes a controller C1, a storage C2, and a driver C3.

The controller C1 includes, for example, a processor such as a central processing unit (CPU).

The storage C2 is a memory including a hard disk drive (HDD), a solid-state drive (SSD), an electrically erasable programmable read-only memory (EEPROM), a read-only memory (ROM), and a random access memory (RAM), and so on. The storage C2 stores, for example, various programs, various commands, and various types of information to be processed by the projector 1 during operation.

The controller C1 reads predetermined information from the storage C2 and then outputs control signals of devices to the driver C3. The driver C3 generates a drive signal for each of the light source unit 2, the image forming unit 3, the intake unit 6, and the exhaust unit 7 based on the control signals output from the controller C1.

The exterior housing 5 includes a front surface portion 51, a rear surface portion 52, a left side surface portion 53, a right side surface portion 54, a top surface portion 55, and a bottom surface portion 56. The exterior housing 5 is formed in, for example, a substantially rectangular parallelepiped shape. Note that in FIG. 1, the top surface portion 55 is illustrated as a transparent member in order to illustrate an internal structure of the exterior housing 5.

The front surface portion 51 is a plate-shaped region located at the front side (+Y) in the front-rear direction Y and extending along the X-Z plane.

The rear surface portion 52 is a plate-shaped region located at the rear side (-Y) in the front-rear direction Y and extending along the X-Z plane.

The left side surface portion 53 is a plate-shaped region located at the left side (-X) in the left-right direction X and extending along the Y-Z plane.

The right side surface portion 54 is a plate-shaped region located at the right side (+X) in the left-right direction X and extending along the Y-Z plane.

The top surface portion 55 is a plate-shaped region that connects upper (+Z) end portions of the front surface portion 51, the rear surface portion 52, the left side surface portion 53, and the right side surface portion 54 to each other and extends along the X-Y plane.

The bottom surface portion 56 is a plate-shaped region that connects the lower (-Z) end portions of the front surface portion 51, the rear surface portion 52, the left side surface portion 53, and the right side surface portion 54 to each other and extends along the X-Y plane.

The front surface portion 51 has an opening 51a disposed at substantially the center. The projection optical unit 4 is inserted into the exterior housing 5 through the opening 51a and coupled to the image forming unit 3. In the case of the present embodiment, a front end portion of the projection optical unit 4 is in a state of protruding to the outside of the exterior housing 5 through the opening 51a, but the front end portion of the projection optical unit 4 may be located at an inner side of the exterior housing 5 from the opening 51a.

In the exterior housing 5, the intake unit 6 is disposed at the left side (-X) of the image forming unit 3. The left side surface portion 53 of the exterior housing 5 has an intake port 53a. The intake port 53a is disposed at a position facing the intake unit 6 and takes in the outside air K into the exterior housing 5.

In the exterior housing 5, the exhaust unit 7 is disposed at the right side (+X) of the image forming unit 3. The right side surface portion 54 of the exterior housing 5 has an exhaust port 54a. The exhaust port 54a is disposed at a position facing the exhaust unit 7. The exhaust unit 7 is an exhaust fan such as a centrifugal fan or a sirocco fan that releases heat from the inside of the exterior housing 5 to the outside.

Based on such a configuration, the projector 1 according to the present embodiment can discharge the air, that has been supplied to the exterior housing 5 by the intake unit 6 and has been warmed after cooling the heat source, to the outside of the exterior housing 5 with the exhaust unit 7.

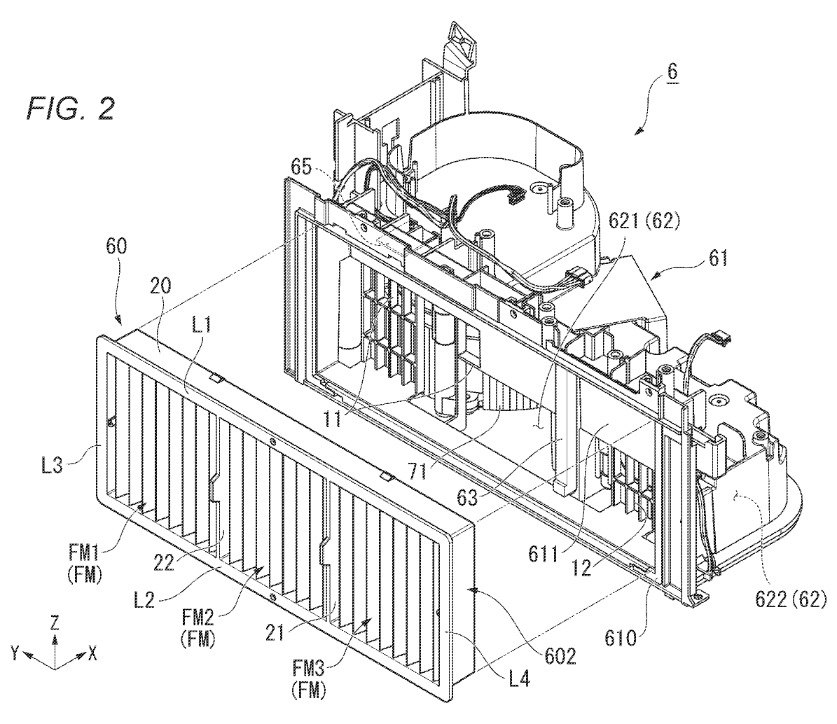

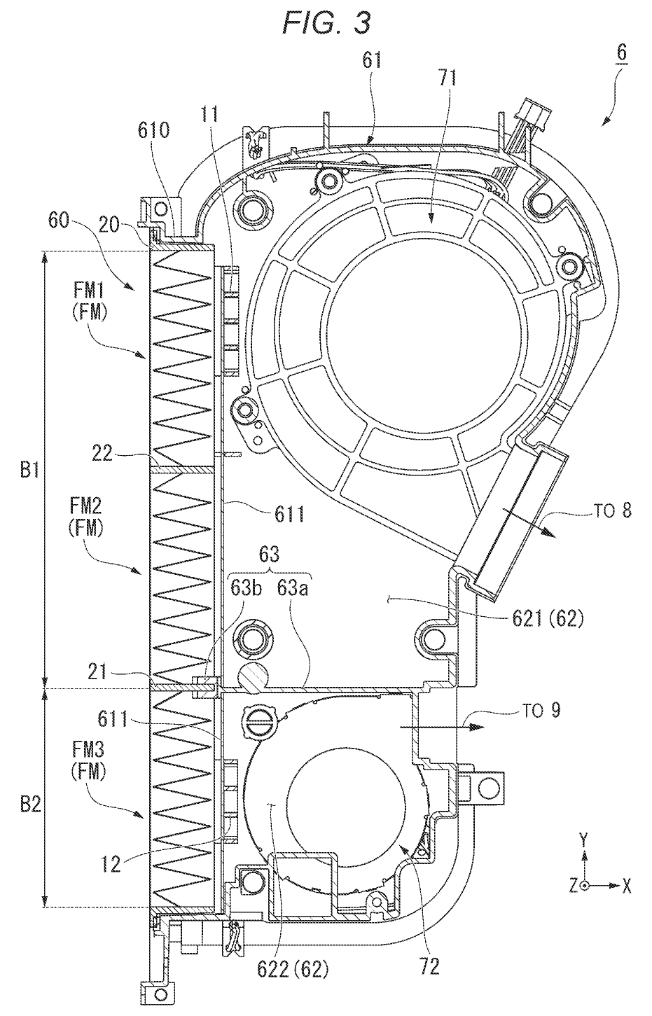

FIG. 2 is an exploded perspective view showing the configuration of the intake unit 6. FIG. 3 is a plan view showing an internal configuration of the intake unit 6. Note that in FIG. 3, an intake case 61 is illustrated as a transparent member in order to make the internal configuration easy to see.

As shown in FIGS. 2 and 3, the intake unit 6 includes the filter 60, the intake case 61, an intake chamber 62, the first fan 71, the second fan 72, a partition 63, and a pressure sensor 65.

The filter 60 is disposed in the intake port 53a of the exterior housing 5 and captures the dust contained in the air K taken into the inside from the intake port 53a. The filter 60 is held by the intake case 61. The filter 60 is fixed to a fixation portion 610 of the intake case 61. Details of the filter 60 will be described later.

The intake case 61 forms the intake chamber 62. The intake chamber 62 takes in the air K through the filter 60. The first fan 71 and the second fan 72 are provided to the intake chamber 62.

Here, a configuration in which two or more (e.g., two) intake chambers provided with fans are installed, that is, two intake units are provided is also conceivable. However, in this case, since a plurality of spaces for housing the intake units are required, there is a problem that the projector itself grows in size. In addition, when a plurality of intake chambers are installed, a plurality of filters are also required, and thus a user needs to replace the filters at a plurality of positions at the time of maintenance, which makes maintenance work complicated.

In contrast, the intake unit 6 in the present embodiment is premised on a configuration in which the two fans 71, 72 are housed in one intake chamber 62 and one filter 60 is disposed for one intake chamber 62. Thus, the intake unit 6 in the present embodiment achieves an improvement in the convenience of the maintenance work while achieving the reduction in size of the projector 1.

As shown in FIG. 3, the intake chamber 62 includes a first space 621 in which the first fan 71 is disposed and a second space 622 in which the second fan 72 is disposed. As the first fan 71 and the second fan 72, for example, a centrifugal fan or a sirocco fan can be used, but the type of the fan is not limited thereto. In the present embodiment, for example, sirocco fans are used as the first fan 71 and the second fan 72.

In the present embodiment, the first fan 71 and the second fan 72 are different in specifications or size from each other, and the first fan 71 is formed of a larger fan than the second fan 72. Therefore, the intake capacity of the first fan 71 is higher than the intake capacity of the second fan 72. In the case of the present embodiment, the intake capacity of the first fan 71 is set twice as high as the intake capacity of the second fan 72.

In the present specification, the intake capacity means an intake volume of the air by a fan that operates when the projector is driven. That is, how high the intake capacity is means a magnitude of an intake volume actually generated during driving.

Therefore, a situation in which the intake volume of the first fan 71 becomes larger than the intake volume of the second fan 72 by driving the first fan 71 and the second fan 72 under respective driving conditions different from each other when the first fan 71 and the second fan 72 supposedly have the same configuration (the same specifications and size) and have no difference in performance means that the intake capacity of the first fan 71 is higher than the intake capacity of the second fan 72.

The partition 63 is a member that partitions the intake chamber 62 as an internal space of the intake case 61. The partition 63 may be formed of a part of the intake case 61 or may be configured with a member different from the intake case 61. In the intake chamber 62, the first space 621 and the second space 622 are partitioned by the partition 63. The partition 63 includes a plate portion 63a that partitions the intake chamber 62, and a coupling portion 63b that protrudes from a tip of the plate portion 63a toward the filter 60 and is coupled to the filter 60.

Based on such a configuration, since the first space 621 and the second space 622 of the intake chamber 62 are separated by the partition 63, the inflow of the air between the first space 621 and the second space 622 is restricted. Therefore, the first space 621 and the second space 622 can take in only the air K that has been transmitted through the filter 60.

As described above, since the first fan 71 is a larger fan than the second fan 72, the first space 621 in which the first fan 71 is housed is larger than the second space 622 in which the second fan 72 is housed.

The filter 60 includes a filter body FM and a holding frame 602 that holds the filter body FM. The filter body FM is formed of a member capable of capturing dust, such as a nonwoven fabric or a mesh member.

The holding frame 602 includes a frame body 20 that surrounds the outer circumference of the filter body FM, and a first partition wall 21 and a second partition wall 22 that divide a region surrounded by the frame body 20 shaped like a rectangular frame. In a plan view, the frame body 20 has a first side portion L1 and a second side portion L2 that form long sides of a rectangular shape and face each other, and a third side portion L3 and a fourth side portion L4 that form short sides of the rectangular shape and face each other.

The filter body FM includes a first filter portion FM1, a second filter portion FM2, and a third filter portion FM3. The first filter portion FM1, the second filter portion FM2, and the third filter portion FM3 are the same in size.

The first filter portion FM1 is disposed in a region surrounded by the frame body 20 and the first partition wall 21. The second filter portion FM2 is disposed in a region surrounded by the frame body 20, the first partition wall 21, and the second partition wall 22. The third filter portion FM3 is disposed in a region surrounded by the frame body 20 and the second partition wall 22.

The fixation portion 610 holds the holding frame 602 so as to surround outer side surfaces of the holding frame 602 to thereby fix the filter 60 in a state in which an opposite surface of the filter 60 to an intake surface is in contact with a case side wall 611 or is opposed, with a slight gap, to the case side wall 611. The case side wall 611 has a first air intake port 11 communicating with the first space 621 and a second air intake port 12 communicating with the second space 622. Accordingly, the first fan 71 is arranged to take in the air K, which has been taken in through the filter 60, into the first space 621 from the first air intake port 11. Further, the second fan 72 is arranged to take in the air K, which has been taken in through the filter 60, into the second space 622 from the second air intake port 12.

The filter 60 in the present embodiment can be fixed to the fixation portion 610 of the intake case 61 even when the orientation in the left-right direction is flipped. Therefore, in the intake unit 6 in the present embodiment, since there are two mounting directions of the filter 60, it is possible to improve the workability of the user in the filter replacement.

When the filter 60 is fixed to the fixation portion 610 in an orientation in which the first side portion L1 is located at the upper side (+Z) and the second side portion L2 is located at the lower side (-Z), the first partition wall 21 of the filter 60 is coupled to the coupling portion 63b of the partition 63. Meanwhile, when the filter 60 is fixed to the fixation portion 610 in an orientation in which the second side portion L2 is located at the upper side (+Z) and the first side portion L1 is located at the lower side (-Z), the second partition wall 22 of the filter 60 is coupled to the coupling portion 63b of the partition 63.

Hereinafter, a state in which the first partition wall 21 is coupled to the partition 63 is referred to as a first state, and a state in which the second partition wall 22 is coupled to the partition 63 is referred to as a second state.

That is, the positions of the first side portion L1 and the second side portion L2 with respect to the partition 63 in the second state are opposite to the positions of the first side portion L1 and the second side portion L2 with respect to the partition 63 in the first state.

As shown in FIG. 3, in the first state, the filter body FM is partitioned by the first partition wall 21 into a first region B1 corresponding to the first space 621 and a second region B2 corresponding to the second space 622. In the first state, the first region B1 corresponds to the first filter portion FM1 and the second filter portion FM2 of the filter body FM, and the second region B2 corresponds to the third filter portion FM3 of the filter body FM.

In the first state, the first partition wall 21 is fitted to the coupling portion 63b of the partition 63, so that the filter 60 is divided in a state where inflow of the air does not occur between the first region B1 and the second region B2. That is, the first partition wall 21 is coupled to the partition 63 in a state where the filter 60 is fixed to the fixation portion 610, and further separates, together with the partition 63, the air K taken into the exterior housing 5 through the filter 60 into the air flowing into the first space 621 and the air flowing into the second space 622. Therefore, the first fan 71 takes in the air through the first filter portion FM1 and the second filter portion FM2 corresponding to the first region B1 of the filter 60, and the second fan 72 takes in the air through the third filter portion FM3 corresponding to the second region B2 of the filter 60.

On the other hand, in the case of the second state in which the position of the filter 60 shown in FIG. 2 is flipped, the filter body FM is partitioned by the second partition wall 22 into the first region B1 corresponding to the first space 621 and the second region B2 corresponding to the second space 622. In the second state, the first region B1 corresponds to the second filter portion FM2 and the third filter portion FM3 of the filter body FM, and the second region B2 corresponds to the first filter portion FM1 of the filter body FM.

In the second state, the second partition wall 22 is fitted to the coupling portion 63b of the partition 63, so that the filter 60 is divided in a state where inflow of the air does not occur between the first region B1 and the second region B2. That is, the second partition wall 22 is coupled to the partition 63 in a state where the filter 60 is fixed to the fixation portion 610, and further separates, together with the partition 63, the air K taken into the exterior housing 5 through the filter 60 into the air flowing into the first space 621 and the air flowing into the second space 622. Therefore, the first fan 71 takes in the air through the second filter portion FM2 and the third filter portion FM3 corresponding to the first region B1 of the filter 60, and the second fan 72 takes in the air through the first filter portion FM1 corresponding to the second region B2 of the filter 60.

As described above, in the intake unit 6 in the present embodiment, it is arranged that the air that has been transmitted through the first region B1 of the filter 60 is supplied to the first space 621, and the air that has been transmitted through the second region B2 of the filter 60 is supplied to the second space 622.

The pressure sensor 65 detects the pressure in the first space 621 of the intake chamber 62. The pressure sensor 65 in the present embodiment is disposed outside the intake case 61, and at least a light receiving surface of the sensor is disposed in the first space 621 via a through hole (not illustrated). The pressure sensor 65 is electrically coupled to the control device CONT of the projector 1. The pressure sensor 65 outputs a detection result to the control device CONT.

When the projector 1 according to the present embodiment is driven, the control device CONT controls the first fan 71 and the second fan 72 based on the detection result of the pressure sensor 65. The control device CONT compares the detection result of the pressure sensor 65 with a threshold value stored in the storage C2. When the detection result of the pressure sensor 65 is higher than the threshold value, the control device CONT determines that clogging does not occur in the filter 60, and performs control to continue driving the first fan 71 and the second fan 72.

The air that has been taken in by the first fan 71 is supplied to the light modulation panels 33B, 33G through the first duct member 8 to cool the light modulation panels 33B, 33G. The air taken in by the second fan 72 cools the light modulation panel 33R and the polarization conversion element 313 through the second duct member 9. Thus, the projector 1 according to the present embodiment can suppress the temperature rise of the light modulation panels 33B, 33G, and 33R and the polarization conversion element 313 as the heat sources while preventing adhesion of dust.

Here, as a comparative example, an advantage obtained by the intake unit 6 in the present embodiment will be described by comparing the intake unit 6 with a configuration in which the partition 63 that partitions the first space 621 and the second space 622 is not provided.

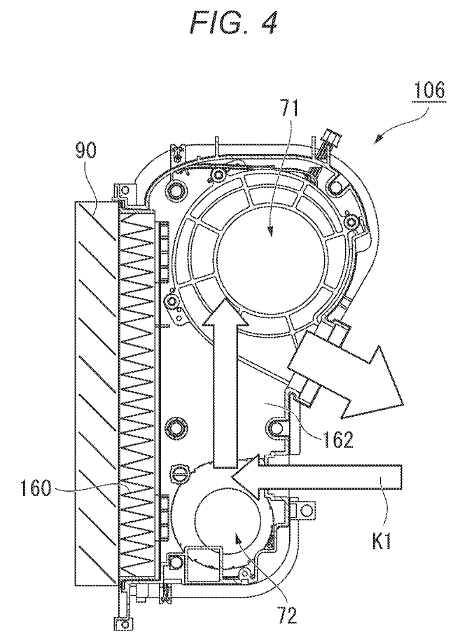

FIG. 4 is a diagram illustrating a configuration of an intake unit in the comparative example. FIG. 4 is a diagram corresponding to FIG. 3 showing the configuration of the intake unit 6 in the present embodiment.

As shown in FIG. 4, an intake unit 106 in the comparative example has a single space since an intake chamber 162 is not partitioned. Further, a filter 160 in the intake unit 106 in the comparative example does not include the first partition wall 21 and the second partition wall 22 to be coupled to the partition 63.

In the intake unit 106 in the comparative example having such a configuration, it is assumed that clogging due to a deposit 90 has occurred in the filter 160. On this occasion, when the first fan 71 and the second fan 72 different in intake capacity are disposed in the intake chamber 162, the first fan 71 relatively higher in intake capacity takes in, via the second fan 72, air K1 that is located inside the exterior housing 5, and is easier to take in instead of taking in, via the filter 160, the air K1 located outside the exterior housing 5. Note that although not illustrated in FIG. 4, the air K1 located inside the exterior housing 5 is taken into the second fan 72 through the second duct member 9.

That is, in the intake unit 106 in the comparative example, when the clogging with the deposit 90 such as dust occurs in the filter 160, there is created a state in which the air K1 located inside the exterior housing 5 flows backward through the second fan 72 and is circulated inside the exterior housing 5 by the first fan 71. Since the air flowing backward through the second fan 72 is the air warmed by the heat sources located inside the exterior housing 5, the first fan 71 supplies the air high in temperature to the heat sources located inside the exterior housing 5. Therefore, the cooling performance of the heat sources by the first fan 71 is significantly degraded, and the second fan 72 cannot cool the heat sources.

In the intake unit 106 in the comparative example, the pressure in the intake chamber 162 is detected, but since the pressure in the intake chamber 162 is less likely to decrease due to the air flowing backward from the second fan 72, the decrease in pressure in the intake chamber 162 cannot satisfactorily be detected. Therefore, in the intake unit 106 in the comparative example, even when the pressure in the intake chamber 162 is detected, it is difficult to determine whether clogging occurs in the filter 160.

Therefore, in the intake unit 106 in the comparative example, when clogging occurs in the filter 160, the temperature of the heat sources inside the exterior housing 5 becomes too high, and thus there is a concern that malfunction, failure due to exposure to a high temperature, and so on may occur.

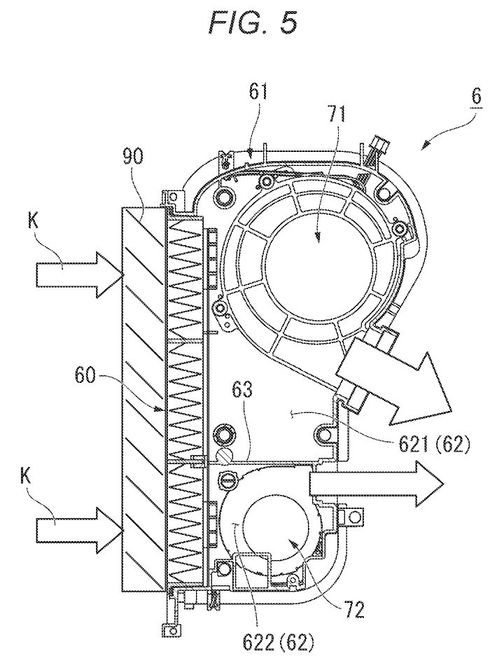

FIG. 5 is a diagram illustrating the flow of the air in the intake unit 6 in the present embodiment.

In contrast to the configuration in the comparative example, in the intake unit 6 in the present embodiment, since the first space 621 in which the first fan 71 is disposed and the second space 622 in which the second fan 72 is disposed are separated by the partition 63, the first fan 71 does not take in the air from the second space 622 side. Therefore, even when clogging with the deposit 90 occurs in the filter 60, the first fan 71 higher in intake capacity takes in the air K via the filter 60 as shown in FIG. 5. Similarly, the second fan 72 takes in the air K through the filter 60.

In the intake unit 6 in the present embodiment, when clogging occurs in the filter 60, for example, the amount of air taken in by the first fan 71 from the outside via the filter 60 decreases, and therefore, in the first space 621, the amount of air discharged by the first fan 71 is larger than the amount of air supplied from the outside. Therefore, when clogging starts occurring in the filter 60, the amount of air discharged from the first space 621 increases, and thus, the pressure in the first space 621 starts decreasing.

In the projector 1 according to the present embodiment, the pressure in the first space 621 is detected by the pressure sensor 65, and the detection result is output to the control device CONT.

When the detection result of the pressure sensor 65 is lower than the threshold value, the control device CONT determines that clogging occurs in the filter 60. On this occasion, the control device CONT increases the intake volumes of the first fan 71 and the second fan 72. For example, the control device CONT raises the drive voltages supplied to the first fan 71 and the second fan 72.

Accordingly, the first fan 71 and the second fan 72 can compensate for a decrease in the intake volume of the air K caused by the clogging in the filter 60. Therefore, the first fan 71 and the second fan 72 can stably supply the air K to the heat sources even when the clogging occurs in the filter 60.

As described above, according to the intake unit 6 in the present embodiment, even when clogging occurs in the filter 60, the air inside the exterior housing 5 does not flow backward unlike the intake unit 106 in the comparative example.

Meanwhile, when the control device CONT determines that the pressure in the first space 621 has reached a lower limit value based on the detection result of the pressure sensor 65, the control device CONT determines that the air K is not taken into the intake chamber 62 via the filter 60 since the filter 60 is completely clogged. Then, the control device CONT stops driving the first fan 71 and the second fan 72. The control device CONT may control the projector 1 to give notice that the filter 60 is clogged and needs to be replaced. As a notification method, it is possible to, for example, turn a lamp on, generate a notification sound, or display a predetermined message for replacing the filter in a projection image.

As described above, in the case of the intake unit 6 in the present embodiment, the pressure sensor 65 is disposed only at the first space 621 side where the first fan 71 relatively high in intake capacity is disposed. The first space 621 where the fan high in intake capacity is disposed is larger in amount of pressure change when clogging occurs in the filter 60 than the second space 622. Therefore, the projector 1 according to the present embodiment detects, with the pressure sensor 65, the pressure in the first space 621 where the pressure change due to the clogging in the filter 60 is more easily detected than in the second space 622. Accordingly, the control device CONT can accurately determine the occurrence of clogging in the filter 60.

Further, in the projector 1 according to the present embodiment, the sizes of the first space 621 and the second space 622 are set in accordance with the intake capacities of the first fan 71 and the second fan 72. That is, an area ratio between the first region B1 of the filter 60 disposed in the first space 621 and the second region B2 of the filter 60 disposed in the second space 622 is set to the same value as a ratio of the intake capacities of the fans 71, 72. Therefore, in the projector 1 according to the present embodiment, a value per unit area in the air intake volume through the filter 60 is made equal between the first space 621 and the second space 622.

Therefore, in the projector 1 according to the present embodiment, a degree of clogging occurring in the first region B1 of the filter 60 disposed in the first space 621 and a degree of clogging occurring in the second region B2 of the filter 60 disposed in the second space 622 can be regarded as substantially the same over time. Therefore, when clogging occurs in the first region B1 of the filter 60, clogging to the same extent also occurs in the second region B2 of the filter 60. Therefore, the projector 1 according to the present embodiment can determine whether clogging occurs in the entire area of the filter 60 based on the clogging occurring in the first region B1 which is a part of the filter 60. In addition, since the degree of clogging occurring in the filter 60 is equal between the first region B1 and the second region B2, the filter 60 can be used without waste.

As described above, the projector 1 according to the present embodiment includes the exterior housing 5 having the intake port 53a through which the air K is taken inside and constituting the exterior, the filter 60 disposed in the intake port 53a, the intake chamber 62 that takes in the air through the filter 60, the first fan 71 and the second fan 72 disposed in the intake chamber 62, and the partition 63 that partitions, in the intake chamber 62, the first space 621 in which the first fan 71 is disposed and the second space 622 in which the second fan 72 is disposed. The intake capacity of the first fan 71 is higher than the intake capacity of the second fan 72.

As described above, according to the projector 1 in the present embodiment, in the intake unit 6 that takes in the air through the filter 60 into the intake chamber 62 housing two fans different in intake capacity, even when clogging occurs in the filter 60, it is possible to prevent the air located inside the exterior housing 5 from flowing backward into the intake chamber 62. Accordingly, it is possible to efficiently cool the light modulation panels 33B, 33G, and 33R and the polarization conversion element 313 which are the heat sources housed inside the exterior housing 5. Therefore, it is possible to suppress the occurrence of defects caused by clogging in the filter 60, such as malfunction of the light modulation panels 33B, 33G, and 33R and the polarization conversion element 313 or failure due to the heat.

Further, in the projector 1 according to the present embodiment, since the pressure sensor 65 is disposed at the first space 621 side where the pressure change is easily detected and no pressure sensor is disposed at the second space 622 side, it is possible to determine the presence or absence of clogging in the filter 60 while simplifying the configuration compared to when disposing two pressure sensors. Therefore, the projector 1 according to the present embodiment can achieve cost reduction by reducing the number of components.

The technical scope of the present disclosure is not limited to the embodiment described above, and various modifications can be made therein without departing from the spirit and scope of the present disclosure.

For example, in the embodiment described above, there is cited as an example when the fixation portion 610 for fixing the filter 60 is provided to the intake case 61, but a fixation portion for fixing the filter 60 may be provided at the exterior housing 5 side.

Besides the above, the specific descriptions of the shapes, the numbers, the arrangements, the materials, and the like of the elements of the projector are not limited to those in the embodiment described above, and can be changed as appropriate.

The present disclosure will be summarized below as appendices.

### Appendix 1

A projector including an exterior housing having an intake port through which air is taken inside, and forming an exterior, a filter disposed in the intake port, an intake chamber configured to take in the air through the filter, a first fan and a second fan disposed in the intake chamber, and a partition configured to partition a first space in which the first fan is disposed and a second space in which the second fan is disposed in the intake chamber, wherein an intake capacity of the first fan is higher than an intake capacity of the second fan.

According to the projector having the configuration described above, when the air is taken in through the filter into the intake chamber housing the two fans different in intake capacity, the air located inside the exterior housing can be prevented from flowing backward into the intake chamber even when clogging occurs in the filter. Accordingly, it is possible to efficiently cool the optical components serving as heat sources housed inside the exterior housing. Therefore, according to this configuration, it is possible to suppress the occurrence of a problem such as malfunction of the optical component or failure due to the heat caused by the clogging in the filter.

### Appendix 2

The projector according to Appendix 1, further including a pressure sensor configured to detect pressure in the first space of the intake chamber, and a control device configured to control the first fan and the second fan based on a detection result of the pressure sensor.

Here, the first space in which the first fan high in intake capacity is disposed is larger in amount of pressure change when clogging occurs in the filter than the second space. According to this configuration, since the pressure sensor is disposed in the first space in which a pressure change due to the clogging in the filter is likely to occur, it is possible to control driving of the first fan and the second fan with high accuracy. In addition, compared to when providing two pressure sensors, it is possible to achieve a cost reduction by simplifying the configuration to reduce the number of components.

### Appendix 3

The projector according to Appendix 2, wherein when the detection result is lower than a threshold value, the control device determines that clogging occurs in the filter and increases intake volumes of the first fan and the second fan.

According to this configuration, the first fan and the second fan can compensate for a decrease in the intake volume of the air caused by the clogging in the filter. Therefore, the first fan and the second fan can maintain the cooling performance by stably supplying the air even when the clogging occurs in the filter.

### Appendix 4

The projector according to any one of Appendices 1 to 3, wherein the filter includes a filter body and a holding frame configured to hold the filter body, and the holding frame includes a first partition wall that is coupled to the partition and partitions the filter body into a first region corresponding to the first space and a second region corresponding to the second space.

According to this configuration, one filter can be divided into the first region and the second region. Therefore, it is possible to supply the air that has been transmitted through the first region of the filter to the first space, and the air that has been transmitted through the second region of the filter to the second space.

### Appendix 5

The projector according to Appendix 4, wherein the holding frame further includes a first side portion and a second side portion facing each other, and a second partition wall coupled to the partition when the filter is disposed in the intake port in a second state in which positions of the first side portion and the second side portion with respect to the partition are opposite to positions of the first side portion and the second side portion with respect to the partition in a first state in which the partition and the first partition wall are coupled to each other.

According to this configuration, since there are two mounting directions of the filter, it is possible to improve workability of user in filter replacement.

### Appendix 6

The projector according to any one of Appendices 1 to 5, further including an intake case that forms the intake chamber, wherein the intake case includes a fixation portion configured to fix the filter.

According to this configuration, it is possible to configure the intake unit in which the first fan and the second fan are housed in the intake chamber in the intake case to which the filter is fixed.

### Appendix 7

The projector according to any one of Appendices 1 to 6, wherein the first fan and the second fan are different in specification or size from each other.

According to this configuration, it is possible to easily realize a configuration in which the first fan and the second fan are made different in intake capacity by using fans different in specification or size from each other.

### Appendix 8

The projector according to any one of Appendices 1 to 6, wherein the first fan and the second fan are formed of fans same in configuration and are driven under respective driving conditions different from each other.

According to this configuration, even when fans the same in configuration are used, it is possible to easily realize a configuration in which the first fan and the second fan are made different in intake capacity by making the driving conditions different from each other.

What is claimed is:

1. A projector comprising:
an exterior housing having an intake port through which air is taken inside, and forming an exterior;
a filter disposed in the intake port;
an intake chamber configured to take in the air through the filter;
a first fan and a second fan disposed in the intake chamber; and
a partition configured to partition a first space in which the first fan is disposed and a second space in which the second fan is disposed in the intake chamber, wherein
an intake capacity of the first fan is higher than an intake capacity of the second fan.

2. The projector according to claim 1, further comprising:
a pressure sensor configured to detect pressure in the first space of the intake chamber; and
a control device configured to control the first fan and the second fan based on a detection result of the pressure sensor.

3. The projector according to claim 2, wherein
when the detection result is lower than a threshold value, the control device determines that clogging occurs in the filter and increases intake volumes of the first fan and the second fan.

4. The projector according to claim 1, wherein
the filter includes a filter body and a holding frame configured to hold the filter body, and
the holding frame includes a first partition wall that is coupled to the partition and partitions the filter body into a first region corresponding to the first space and a second region corresponding to the second space.

5. The projector according to claim 4, wherein
the holding frame further includes
a first side portion and a second side portion facing each other, and
a second partition wall coupled to the partition when the filter is disposed in the intake port in a second state in which positions of the first side portion and the second side portion with respect to the partition are opposite to positions of the first side portion and the second side portion with respect to the partition in a first state in which the partition and the first partition wall are coupled to each other.

6. The projector according to claim 1, further comprising
an intake case that forms the intake chamber, wherein
the intake case includes a fixation portion configured to fix the filter.

7. The projector according to claim 1, wherein
the first fan and the second fan are different in specification or size from each other.

8. The projector according to claim 1, wherein
the first fan and the second fan are formed of fans same in configuration and are driven under respective driving conditions different from each other.
